(19) United States
(12) Patent Application Publication
(10) Pub. No.: US 2015/0288629 A1
(43) Pub. Date: Oct. 8, 2015

(54) ELECTRONIC DEVICE AND METHOD OF PROVIDING INFORMATION BY ELECTRONIC DEVICE

(71) Applicant: Samsung Electronics Co., Ltd., Suwon-si (KR)

(72) Inventors: Wonsuk CHOI, Seoul (KR); Kwangweon PARK, Yongin-si (KR); Jihyun PARK, Seongnam-si (KR); Seokjun BAEK, Suwon-si (KR); Kwangsub SON, Suwon-si (KR); Sungho SON, Daegu (KR); Suha YOON, Seoul (KR); Youngeun HAN, Seongnam-si (KR)

(21) Appl. No.: 14/671,205

(22) Filed: Mar. 27, 2015

(30) Foreign Application Priority Data
Apr. 4, 2014 (KR) 10-2014-0040806

(51) Int. Cl. H04L 12/58

(52) U.S. Cl. CPC H04L 51/046; H04L 51/24; H04L 51/32

(57) ABSTRACT

A method of providing information by an electronic device is provided. The method includes executing a function related to a specific person while executing a function of a first electronic device, changing a display order of information related to the specific person when the information related to the specific person exists, and transmitting a changed matter of the changed information to a second electronic device.

### CROSS-REFERENCE TO RELATED APPLICATION(S)

This application claims the benefit under 35 U.S.C. §119(a) of a Korean patent application filed on Apr. 4, 2014 in the Korean Intellectual Property Office and assigned Serial number 10-2014-0040806, the entire disclosure of which is hereby incorporated by reference.

### TECHNICAL FIELD

The present disclosure relates to an electronic device and a method of providing information by the electronic device.

### BACKGROUND

In consideration of recent development of communication technologies, an electronic device is implemented in the form of integratively supporting various user functions, such as image photography, multimedia reproduction, gaming, and broadcasting reception. According to the variety of the user functions of the electronic device, the electronic device supports a notification service of notifying information based on the generation of a specific event.

The above information is presented as background information only to assist with an understanding of the present disclosure. No determination has been made, and no assertion is made, as to whether any of the above might be applicable as prior art with regard to the present disclosure.

### SUMMARY

When a plurality of elements of unconfirmed notification information is generated in the electronic device, the unconfirmed notification information is displayed according to a predefined display order. For example, when there is a plurality of unconfirmed messages, a top priority order may be assigned to the most recently received message, and the message assigned with the top priority order may be displayed on a display of the electronic device. When a user confirms unconfirmed notification information, which does not have the top priority order, or notification information related to a specific person, the user needs to inconveniently confirm a plurality of elements of overlapping notification information according to an input of the user.

Aspects of the present disclosure are to address at least the above-mentioned problems and/or disadvantages and to provide at least the advantages described below. Accordingly, an aspect of the present disclosure is to provide an electronic device, which is capable of providing a notification that notifies of information on the generation of a specific event, and a method of providing information by the electronic device.

In accordance with an aspect of the present disclosure, a method of providing information by an electronic device is provided. The method includes executing a function related to a specific person while executing a function of a first electronic device, changing a display order of information related to the specific person when the information related to the specific person exists, and transmitting a changed matter of the changed information to a second electronic device.

In accordance with another aspect of the present disclosure, a method of providing a notification object by an electronic device connected with a peripheral device is provided. The method includes receiving information about an execution start of a function related to a specific person or information on a changed order of a specific notification object from a peripheral device, changing a display order of a notification object related to the specific person in response to the information about an execution start of the function or the order information, and displaying the notification object, of which the display order is changed, on a display functionally connected with the electronic device.

In accordance with another aspect of the present disclosure, an electronic device is provided. The electronic device includes a communication module configured to wirelessly communicate with other electronic devices, a processor configured to execute a function related to a specific person, to change a display order of information related to the specific person when the information related to the specific person exists, and to provide at least one of the changed information or a change matter of the changed information to one or more accessory devices, and a display configured to display at least one of the function related to the specific person and the information related to the specific person.

In accordance with another aspect of the present disclosure, an electronic device is provided. The electronic device includes a communication module configured to wirelessly communicate with other electronic devices, a processor configured to receive a notification object from the electronic device, and to align a display order of the notification object related to a specific person to a top priority order when at least one of display order information about the notification object and execution information about a function related to a specific person is received, and the notification object related to the specific person exists, and a display configured to display the notification object related to the specific person.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment including an electronic device according to various embodiments of the present disclosure;

FIG. 2 is a block diagram illustrating a notification managing module of the electronic device according to various embodiments of the present disclosure;

FIG. 3 is a block diagram illustrating a notification operating module of a peripheral device connected with an electronic device according to various embodiments of the present disclosure;

FIG. 4 is a concept diagram illustrating a notification object transmitting process between an electronic device and a peripheral device according to various embodiments of the present disclosure;

FIG. 5 is a flowchart for describing a notification function operating method of an electronic device according to various embodiments of the present disclosure;

FIG. 6 is a flowchart for describing a notification function operating method of an electronic device according to various embodiments of the present disclosure;

FIG. 7 is a conceptual diagram for describing an operation of a peripheral device interconnected with an electronic device according to various embodiments of the present disclosure;

FIG. 8 is a flowchart for describing a notification function operating method of a peripheral device connected with an electronic device according to various embodiments of the present disclosure;

FIG. 9 is a diagram illustrating an example of a screen image of a notification service operating method according to various embodiments of the present disclosure;

FIG. 10 is a diagram illustrating an example of a screen image of a notification service operating method according to various embodiments of the present disclosure;

FIG. 11 is a flowchart for describing a notification function operating method of an electronic device according to various embodiments of the present disclosure;

FIG. 12 is a diagram illustrating an example of a screen image of a notification service operating method according to various embodiments of the present disclosure; and

FIG. 13 is a block diagram of an electronic device according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or” “have” may be construed to denote a certain characteristic, number, operation, constituent element, component or a combination thereof, but may not be construed to exclude the existence of or a possibility of addition of one or more other characteristics, numbers, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” and/or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of the first user device and the second user device are user devices. For example, a first element could be termed a second element, and similarly, a second element could be also termed a first element without departing from the scope of the present disclosure.

In the case according to which a component is referred to as being “connected” or “accessed” to other component, it should be understood that not only the component is directly connected or accessed to the other component, but also there may exist another component between the component and the other component. Meanwhile, in the case according to which a component is referred to as being “directly connected” or “directly accessed” to other component, it should be understood that there is no component therebetween.

The terms used herein are used only to describe particular embodiments of the present disclosure, and are not intended to limit the present disclosure.

Unless defined otherwise, all terms used herein, including technical and scientific terms, have the same meaning as those commonly understood by a person of ordinary skill in the art to which the present disclosure pertains. Such terms as those defined in a generally used dictionary are to be interpreted to have the meanings equal to the contextual meanings in the relevant field of the art, and are not to be interpreted to have ideal or excessively formal meanings unless clearly defined in the present disclosure.

An electronic device according to the present disclosure may be a device including a communication function. For example, the electronic device may include at least one of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a Moving Pictures Expert Group (MPEG-1 or MPEG-2) Audio Layer 3 (MP3) player, a mobile medical device, a camera, a wearable device (e.g., a Head-Mounted-Device (HMD), such as electronic glasses), electronic clothes, an electronic bracelet, an electronic necklace, an electronic appcessory, an electronic tattoo, and a smart watch.

According to various embodiments of the present disclosure, the electronic device may be a smart home appliance with a communication function. The smart home appliances may include at least one of, for example, televisions (TVs), digital versatile disc (DVD) players, audio players, refrigerators, air conditioners, cleaners, ovens, microwaves, washing machines, air purifiers, set-top boxes, TV boxes (e.g., HomeSync™ of Samsung, Apple TV™, or Google TV™), game consoles, electronic dictionaries, electronic keys, camcorders, electronic frames, and the like.

According to various embodiments of the present disclosure, the electronic device may include at least one of various types of medical devices (e.g., Magnetic Resonance Angiography (MRA), Magnetic Resonance Imaging (MRI), Computed Tomography (CT), a scanning machine, ultrasonic wave device and the like), a navigation device, a Global Positioning System (GPS) receiver, an Event Data Recorder (EDR), a Flight Data Recorder (FDR), a car infotainment device, ship electronic equipment (e.g., navigation equipment for a ship, a gyro compass and the like), avionics, a security device, and an industrial robot or a home robot.

According to various embodiments of the present disclosure, the electronic device may include at least one of a part of furniture or a building/structure having a communication function, an electronic board, an electronic signature receiving device, a projector, and various kinds of measuring instruments (e.g., a water meter, an electric meter, a gas meter, a radio wave meter, and the like). The electronic device according to the present disclosure may be a combination of one or more of the aforementioned various devices. Further, it is obvious to those skilled in the art that the electronic device according to the present disclosure is not limited to the aforementioned devices.

Hereinafter, the electronic device according to various embodiments of the present disclosure will be described with reference to the accompanying drawings. The term “user” used in various embodiments of the present disclosure may refer to a person who uses an electronic device or a device (e.g., an artificial intelligence electronic device) that uses an electronic device.

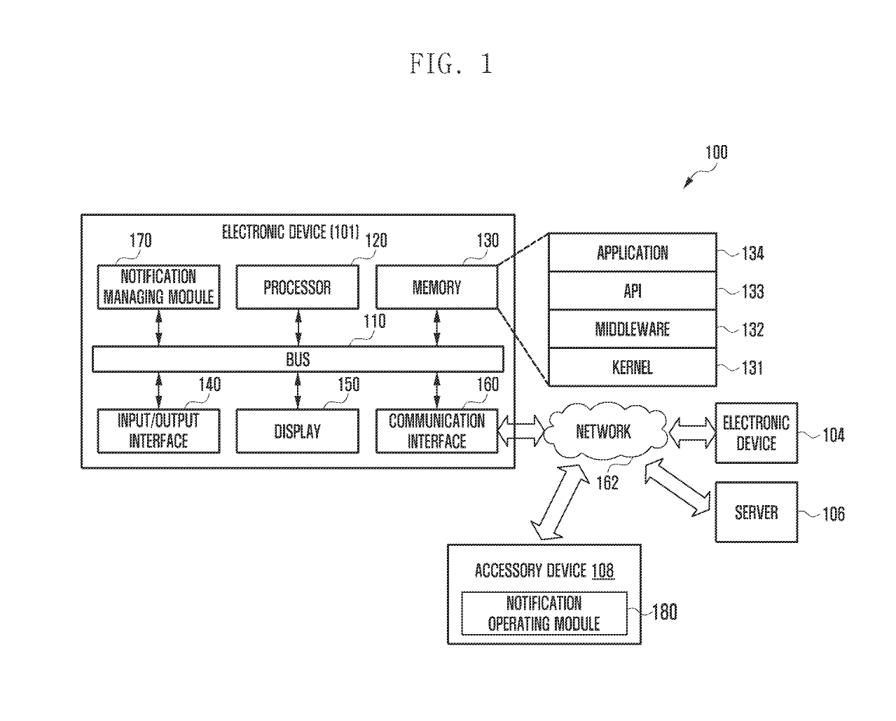

FIG. 1 is a diagram illustrating a network architecture including an electronic device according to various embodiments of the present disclosure.

Referring to FIG. 1, a network architecture 100 according to various embodiments of the present disclosure comprises an electronic device 101, an external electronic device 104, a network 162, a sever 106, and an accessory device 108.

The electronic device 101 may include a bus 110, a processor 120, a memory 130, an input/output interface 140, a display 150, a communication interface 160, and a notification managing module 170.

The bus 110 may be a circuitry which connects the aforementioned components to each other to communicate signals (e.g., control messages) therebetween.

The processor 120 receives a command from any of the aforementioned components (e.g., the memory 130, the input/output interface 140, the display 150, the communication interface 160, and the notification managing module 170) through the bus 110, interprets the command, and executes operation or data processing according to the decrypted command.

The memory 130 may store the command or data received from the processor 120 or other components (e.g., the input/output interface 140, the display 150, the communication interface 160, the notification managing module 170, and the like) or generated by the processor 120 or other components. The memory 130 may store program modules including a kernel 131, a middleware 132, an Application Programming Interface (API) 133, applications 134, and the like. Each programming module may be implemented as software, firmware, hardware, and any combination thereof.

The kernel 131 may control or manage the system resources (e.g., the bus 110, the processor 120, and the memory 130) for use in executing the operation or function implemented with the middleware 132, the API 133, or the application 134. The kernel 131 also may provide an interface allowing the middleware 132, API 133, or application 134 to access the components of the electronic device 101 to control or manage.

The middleware 132 may work as a relay of data communicated between the API 133 or application 134 and the kernel 131. The middleware 132 may execute control of the task requests from the applications 134 in such a way of assigning priority for use of the system resource (e.g., the bus 110, the processor 120, and the memory 130) of the electronic device to at least one of the applications 134.

The API 133 is the interface for the applications 134 to control the function provided by the kernel 131 or the middleware 132 and may include at least one interface or function (e.g., a command) for a file control, a window control, an image control, a text control, and the like.

According to various embodiments of the present disclosure, the applications 134 may include Short Messaging Service (SMS)/Multimedia Messaging Service (MMS) application, email application, calendar application, alarm application, health care application (e.g., application of measuring quantity of motion or blood sugar level), and environmental information application (e.g., atmospheric pressure, humidity, and temperature applications). Additionally or alternatively, the application 134 may be an application related to information exchange between the electronic device 101 and other external electronic device (e.g., an external electronic device 104). Examples of the information exchange application may include a notification relay application for relaying specific information to the external electronic device 104 and a device management application for managing the external electronic device.

For example, the notification relay application may be provided with a function of relaying the alarm information generated by the other applications (e.g., SMS/MMS application, email application, health care application, and environmental information application) of the electronic device to an external electronic device (e.g., the external electronic device 104). Additionally or alternatively, the notification relay application may provide the user with the notification information received from an external electronic device (e.g., the external electronic device 104). The electronic device application may manage (e.g., install, delete, and/or update) the function of an external electronic device (e.g., turn-on/off of the external electronic device 104 (or a part of it) or adjustment of the brightness (or resolution) of the display) which communicates with the electronic device 101 or the service (e.g., communication or messaging service) provided by the external electronic device or an application running on the external device.

According to various embodiments of the present disclosure, the applications 134 may include an application designated according to the property (e.g., a type) of an external electronic device (e.g., the external electronic device 104). If the external electronic device is an MP3 player, the applications 134 may include a music playback application. Similarly, if the external electronic device is a mobile medical appliance, the applications 134 may include a health care application. According to an embodiment of the present disclosure, the application 134 may include at least one of applications designated to the electronic device 101 or the applications received from the external electronic device (e.g., a server 106, the external electronic device 104, and the like).

The input/output interface 140 delivers the command or data input by the user through with an input/output device (e.g., sensor, keyboard, and touchscreen) to the processor 120, memory 130, communication interface 160, and/or the notification managing module 170 through the bus 110. For example, the input/output interface 140 may provide the processor 120 with the data corresponding to the touch made by the user on the touchscreen. The input/output interface 140 may output the command or data (which is received from the processor 120, memory 130, communication interface 160, or the notification managing module 170 through the bus 110) through the input/output device (e.g., speaker and display). For example, the input/out interface 140 may output the voice data processed by the processor 120 to the user through the speaker.

The display 150 may present various information (e.g., multimedia data and text data) to the user.

The communication interface 160 may establish a communication connection of the electronic device 101 with an external device (e.g., the external electronic device 104, the server 106, and the like). For example, the communication interface 160 connects to a network 162 through a wireless or wired link for communication with the external device. Examples of the wireless communication technology may include Wi-Fi, Bluetooth (BT), Near Field Communication (NFC), GPS, and cellular communication technology (e.g., Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

According to an embodiment of the present disclosure, the network 162 may be a telecommunication network. The communication network may include at least one of computer network, Internet, Internet of Things, and telephone network. According to an embodiment of the present disclosure, the communication protocol between the electronic device 101 and an external device (e.g., transport layer protocol, data link layer protocol, and physical layer protocol) may be supported by at least one of the applications 134, API 133, middleware 132, kernel 131, and communication interface 160.

The notification managing module 170 may process at least some pieces of information acquired from other components (e.g., the processor 120, the memory 130, the input/output interface 140, or the communication interface 160), and may provide the processed information to a user through various methods. For example, the communication group control module 170 may control at least some of the functions of the electronic device 101 by using the processor 120 or independently from the processor 120 such that the electronic device 101 interworks with another electronic device (e.g., the external electronic device 104, the server 106, and the like).

In the network environment 100 according to various embodiments of the present disclosure, the accessory device 108 may be connected with the electronic device 101 through short-range communication (e.g., BT) based on communication address information about the electronic device 101. The accessory device 108 may include all or some of the same elements as the elements (e.g., the processor 120, the memory 130, the input/output interface 140, and the communication interface 160) of the electronic device 101.

The accessory device 108 may receive an installation file of an application based on the communication connection with the electronic device 101. The accessory device 108 may execute the installation file of the application and install an application interconnected with the electronic device 101.

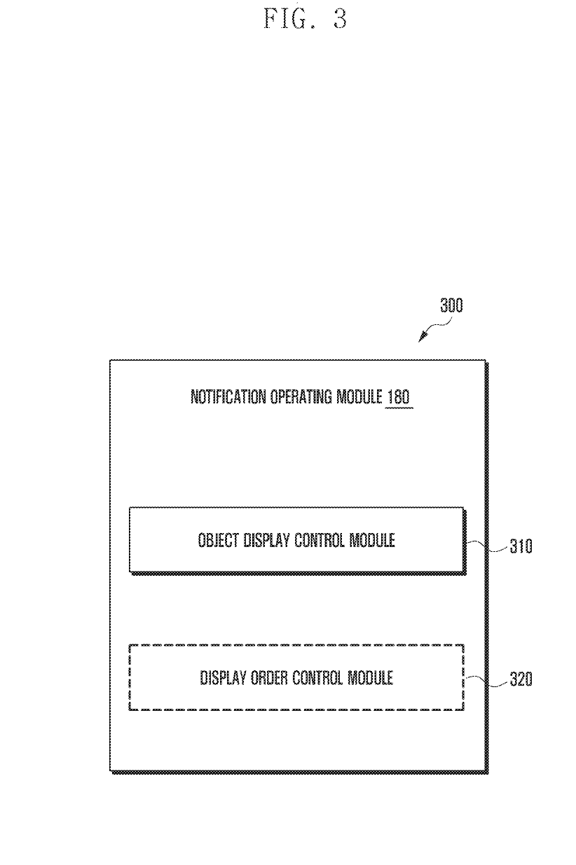

The accessory device 108 may obtain a notification object for one or more applications, which are to be executed while being interconnected with the electronic device 101, from the electronic device 101, and provide the obtained notification object to a user. The accessory device 108 may include a notification operating module 180 for operating the notification object obtained from the electronic device 101. The notification operating module 180 may operate notification information of the electronic device 101 to be visually or audibly expressed while being interconnected with the electronic device 101. The notification operating module 180 of the accessory device 108 will be additionally described with reference to FIG. 3 below.

The electronic device 101 according to various embodiments of the present disclosure may be a host electronic device, a main electronic device, a master device, and a source device for supporting a control of the accessory device 108. The accessory device 108 may be a device limited by a point-to-point connection with the electronic device 101, an auxiliary device, a target device, and a slave device. For example, the accessory device 108 may be a wearable electronic device, such as a smart watch and smart glasses, puttable or wearable on a body, or an electronic device for an accessory, such as an earphone and a wireless keyboard, but is not limited thereto.

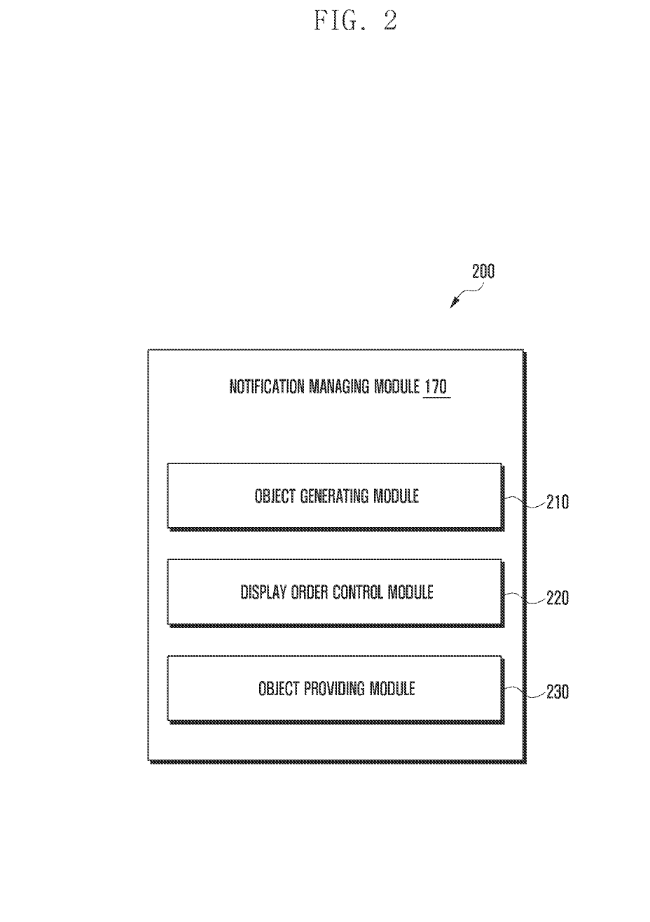

FIG. 2 is a block diagram 200 illustrating a notification managing module of the electronic device (e.g., the electronic device 101) according to various embodiments of the present disclosure.

Referring to FIG. 2, the notification managing module 170 of the electronic device 101 may include an object generating module 210, a display order control module 220, and an object providing module 230.

The object generating module 210 may generate a notification object based on information about applications (e.g., an SMS/MMS application, an email application, a schedule management application, and a call log application) of the electronic device 101.

According to an embodiment of the present disclosure, the object generating module 210 may generate a notification object based on at least one of an icon or text to be displayed on a notification status bar, a notification title, notification text, an effect function (e.g., an effect sound or vibration) to be generated when a notification is provided, information about an operation to be performed when a notification object is selected, and a notification providing time.

According to an embodiment of the present disclosure, when a notification event (e.g., message reception, missed call generation, schedule notification, memo notification, message notification, and email reception) is generated from a designated application or an application supporting a notification service, the object generating module 210 may obtain information for generating a notification object from the corresponding application. For example, when a missed call event is generated in a call log application, the object generating module 210 may obtain information (e.g., a sender, a receiving time, and a number of reception) corresponding to the missed call event, and generate a missed call notification object based on the obtained information. For another example, when a message is received in a message application, the object generating module 210 may obtain information about corresponding message contents (e.g., text, a picture, and a video), and generate a message notification object based on the obtained information.

The object generating module 210 may allocate an intrinsic notification object Identification (ID) in response to the generated notification object. The notification object ID may be provided to the notification operating module 180 of the accessory device 108 through the object providing module 230 together with the generated notification object. The notification object ID may be used when the notification object is confirmed and the notification object is removed. For example, when a reading function is executed on an unconfirmed notification object under the control of the user, the object generating module 210 may transmit an ID of the read notification object and reading information to the accessory device 108. Then, the accessory device 108 recognizes that the unconfirmed notification object linked to the notification object ID is read by the electronic device 101, and remove the notification object stored in the accessory device 108 or change the reading information about the notification object.

The display order control module 220 may assign a display order of a notification object based on a predetermined order or a generation time of the notification event. For example, the display order control module 220 may classify notification objects based on at least one of the type of application of the notification object, information about a sender of the notification object, and the type of notification object, and assign a display order of the notification object according to the classification. Otherwise, the display order control module 220 may assign a display order of the notification object in time series based on the generation time of the notification object.

According to an embodiment of the present disclosure, when a new notification object is generated in a state where the unconfirmed notification object exists, the display order control module 220 may control a display order of the new notification object to be changed to a top priority order (e.g., the first order). In this case, the display order control module 220 may change a display order of the new notification object to the top priority order, and change a display order of the unconfirmed notification object to a next display order (e.g., the first order→the second order).

According to an embodiment of the present disclosure, when a function related to an ID of a sender is executed, the display order control module 220 may control a display order of a notification object related to the ID of the sender to be changed to a top priority order. For example, when there is an unconfirmed message notification object generated based on an ID of a specific person in a state where a call is connected with the specific person, the display order control module 220 may change a display order of an unconfirmed message notification object to a top priority order (e.g., the first order).

According to an embodiment of the present disclosure, when the function related to the ID of the specific person is terminated, the display order control module 220 may return the changed display order of the notification object related to the ID of the specific person to a previous order.

The object providing module 230 may display the notification object to the user through a display 150 functionally connected with the electronic device 101 based on the display order of the notification object or provide at least one of the notification object, display order information about the notification object, and ID information about the notification object to the accessory device 108.

When the display order of the notification object is changed, the object providing module 230 may provide information on the changed display order of the corresponding notification object to the accessory device 108. Otherwise, when a function related to a specific person is executed, the object providing module 230 may provide function start information to the accessory device 108, and when the function related to the specific person is terminated, the object providing module 230 may provide function termination information to the accessory device 108.

FIG. 3 is a block diagram 300 illustrating a notification operating module of a peripheral device connected with an electronic device according to various embodiments of the present disclosure. Here, the peripheral device may be an accessory device, but may include all of the electronic devices connectable with the electronic device. A description will be given on an assumption that the peripheral device is an accessory device for convenience of the description.

Referring to FIG. 3, the notification operating module 180 of the accessory device 108 may include an object display control module 310. The object display control module 310 may receive a notification object from the electronic device 101 based on communication connection with the electronic device 101. To this end, the accessory device 108 may receive an installation file of a notification operating program from the electronic device 101, and install the notification operating program. Otherwise, the notification operating program may be installed in the accessory device 108 in advance.

The object display control module 310 may execute the notification operating program while being interconnected with the electronic device 101, and provide the notification object to the user through a display functionally connected with the accessory device 108. The object display control module 310 may be interconnected with the notification object stored in the electronic device 101 based on an ID of the notification object to display or operate the notification object.

According to an embodiment of the present disclosure, when a display order of the notification object is changed after the object display control module 310 receives the notification object from the electronic device 101, the object display control module 310 may receive information on the changed display order. When information indicating that a display order of a notification object with a specific ID is changed to a top priority order is received, the object display control module 310 may control the notification object, of which the display order is changed to a top priority order, to be displayed on the display.

According to an embodiment of the present disclosure, when function start information or function termination information related to an ID of a specific person is received from the electronic device 101, the object display control module 310 may change a display order of a notification object generated based on the ID of the specific person to a top priority order. To this end, the accessory device 108 may include a display order control module 320, but is not limited thereto. When the electronic device 101 is call-connected with a specific person, the electronic device 101 may provide call function execution information and information on an ID of a specific person to the accessory device 108. Then, when there is an unconfirmed message notification object related to the ID of the call-connected specific person, the display order control module 320 within the accessory device 108 may change a display order of the unconfirmed message notification object to a top priority order. The display order control module 320 may align the display order of the notification object obtained from the electronic device 101, and when the display order is changed, the display order control module 320 may provide information on the changed display order to the object display control module 310. When call function termination information is received from the electronic device 101, the display order control module 320 of the accessory device 108 may return the display order of the notification object, which has been changed to the top priority order in relation to the ID of the specific person, to a previous order.

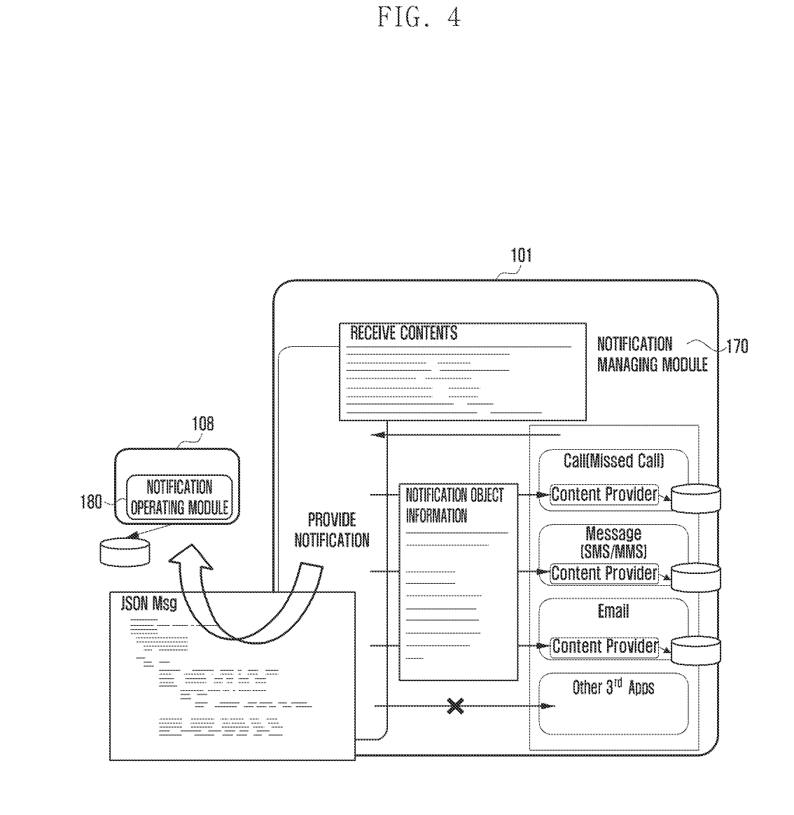

FIG. 4 is a concept diagram illustrating a notification object transmitting process between an electronic device and an accessory device according to various embodiments of the present disclosure.

Referring to FIG. 4, the electronic device 101 illustrated in FIG. 1 may be communication connected with the accessory device 108. The electronic device 101 may execute a notification application while being interconnected with the accessory device 108 through the communication connection. For example, the electronic device 101 may be set so as to transmit an installation file of a notification application to the accessory device 108. The accessory device 108 may install the notification application by using the installation file of the notification application received from the electronic device 101. The electronic device 101 and the accessory device 108 are interconnected through the notification application to provide a notification service function to the user. The electronic device 101 and the accessory device 108 may synchronize a display of the notification object, notification reading confirmation information, and notification object deletion information based on an ID of the notification object.

The electronic device 101 may detect generation of a notification event (e.g., reception of message contents), such as an absence call, message reception, email reception, and schedule notification. When the notification event is generated, the electronic device 101 may obtain notification object generation information from a function application (e.g., a call log application, a message application, and a schedule management application) corresponding to the notification event. Here, the notification object generation information may be at least one of notification event contents, a notification event title, contents included in a notification event, ID information (e.g., a telephone number, an email address, a name, and address information) about a specific person related to a notification event, and notification event reception time information, but is not essentially limited thereto. The notification object generation information may be varied according to the type of function application (e.g., a call log app., a message app., an email app., and a schedule app.)

The electronic device 101 may generate a notification object based on the notification object generation information. For example, constituent elements of the notification object are represented by Table 1, but are not limited thereto.

TABLE 1
Contents to be displayed
Contents displayed on a status bar
→ Icon
→ ticker Text
Time to display
Items displayed in notification list
→ content Title: Title to be displayed in notification list
→ content Text: Contents to be displayed in notification list
Operation to be executed Operation when pressing an item displayed in
notification list
→ content Intent: Operation to be performed when pressing an item

When a time, at which the notification object is to be displayed based on the generated notification object, reaches, the electronic device 101 may display the notification object on the display of the electronic device 101. Further, the electronic device 101 may assign an intrinsic ID to each notification object so as to discriminate the notification object.

The electronic device 101 may transmit the generated notification object to the accessory device 108 through the notification managing module 170. The notification object may be provided to the notification operation module 180 of the accessory device 108 in, for example, a JavaScript Object Notation (JSON) or ˜˜ (MSG) format.

According to an embodiment of the present disclosure, the electronic device 101 may synchronize whether the notification object interconnected with the accessory device 108 is read and a deletion function of the notification object by using the ID of the notification object. For example, the electronic device 101 may transmit the notification object ID assigned to the corresponding notification object together with the notification object when transmitting the notification object to the accessory device 108. In relation to a specific notification object, the notification object stored in the electronic device 101 and the notification object of the accessory device 108 interconnected with the notification object stored in the electronic device 101 may maintain the same ID.

According to an embodiment of the present disclosure, when the accessory device 108 reads an unconfirmed notification object under the control of the user, the accessory device 108 may transmit the information indicating that the notification object is read based on the ID of the read notification object to the electronic device 101. The electronic device 101 may discriminate the unconfirmed notification object corresponding to the notification object ID transmitted from the accessory device 108, and change the corresponding notification object from unconfirmed to read confirmation, or delete the corresponding notification object. By contrast, when the electronic device 101 reads the unconfirmed notification object, the electronic device 101 may transmit the read information to the accessory device 108 based on the notification object ID.

The accessory device 108 may display the notification object provided from the electronic device 101 on the display of the accessory device 108 according to the contents of the notification object through the notification operating module.

When there is a plurality of notification objects, the electronic device 101 and the accessory device 108 may align the notification objects based on a predetermined reference or a time series order, and display a notification object having a top priority order according to the display order of the notification object on the display.

A method of controlling a display of a notification object according to various embodiments of the present disclosure will be described.

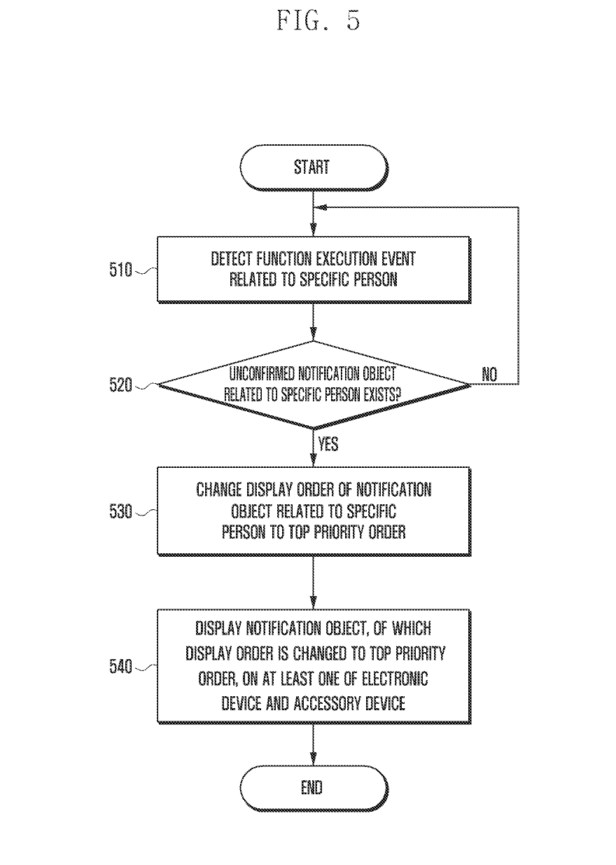

FIG. 5 is a flowchart for describing a notification function operating method of an electronic device according to various embodiments of the present disclosure.

Referring to FIG. 5, the electronic device 101 of FIG. 1 may detect the generation of a function execution event related to a specific person in operation 510. The function execution related to the specific person may be at least one of a call connection function with a specific person, a message sending/receiving function, an email sending/receiving function, a social networking site (SNS) function (e.g., talk message execution and SNS contents execution) associated with the specific person, a schedule associated with the specific person, and a memo function. The function execution event related to the specific person may correspond to a part or all of the functions related to an ID of the specific person among the functions of the electronic device.

In this case, the electronic device 101 may execute an application corresponding to the function execution in response to the function execution event, and display an application execution image on the display.

When the function execution event related to the specific person is detected, the electronic device 101 may determine whether a notification object related to the ID of the specific person exists based on the ID of the specific person in operation 520. For example, the electronic device 101 may confirm a notification object including the ID of the specific person based on the generation information of the notification object.

When a plurality of notification objects is generated in the electronic device 101, the plurality of notification objects may be aligned based on a predefined order or a generation order, and a notification object having a top priority order according to an arrangement order of the notification object may be displayed on the display.

When a notification object related to the specific person exists, the electronic device 101 may change a display order of the notification object related to the specific person to a top priority order in operation 530. For example, when a first notification object, a second notification object, and a third notification object are aligned in the electronic device 101, the third notification object may be the third order, and the first notification object may be a top priority order (e.g., the first order). In this case, when the third notification object is a message notification object received from the specific person, a priority order of the third notification object may be changed to a top priority order (e.g., the third order→the first order).

In various embodiments of the present disclosure, when a notification object related to the specific person does not exist, the electronic device 101 returns to operation 510.

In operation 540, the electronic device 101 may control the notification object, of which the display order is changed to the top priority order, to be displayed on the display of at least one of the electronic device 101 and the accessory device 108. To this end, the electronic device 101 may perform at least one operation of a display of the notification object, of which the priority is changed, on the display of the electronic device 101 according to the top priority order and transmission of priority order change information about the notification object to the accessory device 108.

In an embodiment of the present disclosure, when the display order of the notification object related to the specific person is changed to the top priority order, the electronic device 101 may display the notification object, of which the display order is changed to the top priority order, on a function execution screen image. The electronic device 101 may overlap and display the notification object on a specific region of the function execution screen image or divide a screen and display the notification object. Accordingly, the user may confirm the notification object related to the specific person while the function related to the specific person is executed in the electronic device 101.

In an embodiment of the present disclosure, when the display order of the notification object related to the specific person is changed to the top priority order, the electronic device 101 may provide information on the changed display order to the accessory device 108. For example, the electronic device 101 may transmit ID information about the notification object related to the specific person and the information on the changed display order of the corresponding notification object together. In this case, the accessory device 108 may control the notification object, of which the display order is changed to the top priority order, on the display of the accessory device 108 based on the ID of the notification object. Accordingly, the user may confirm the notification object generated in relation to the specific person through the accessory device 108 while the function related to the specific person is executed through the electronic device 101.

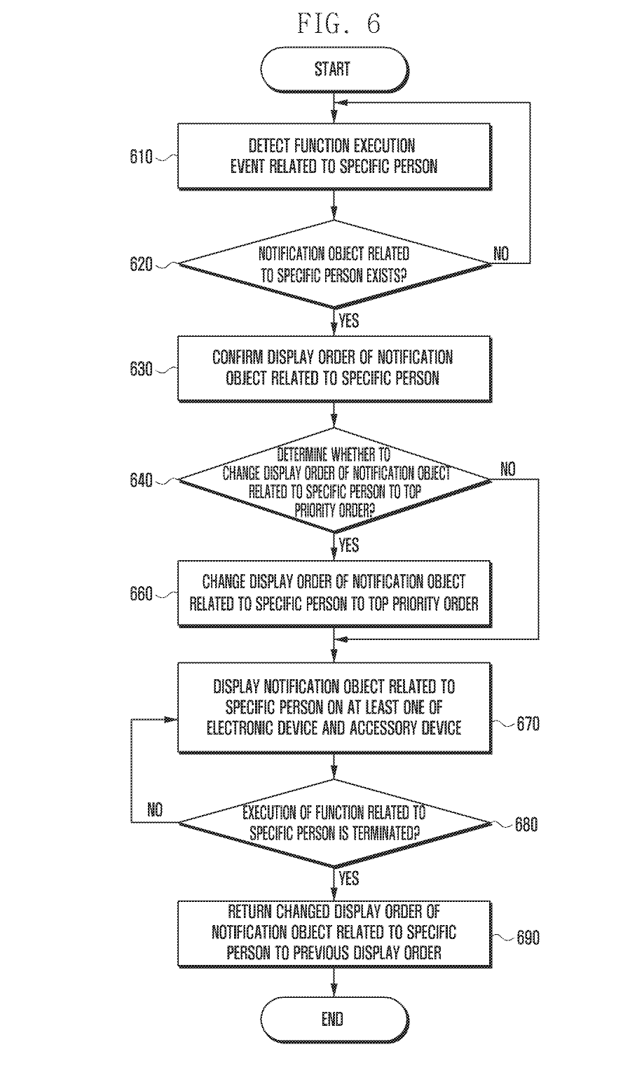

FIG. 6 is a flowchart for describing a notification function operating method of an electronic device according to various embodiments of the present disclosure.

Referring to FIG. 6, the electronic device 101 may detect a function execution event related to a specific person in operation 610. In this case, the electronic device 101 may execute an application corresponding to the function execution in response to the function execution event, and display an application execution screen image on the display.

The electronic device 101 may determine whether a notification object related to the specific person exists in operation 620, and when the notification object related to the specific person exists, the electronic device 101 may confirm a display order of the notification object related to the specific person in operation 630. When a notification object related to the specific person does not exist, the electronic device 101 may return to operation 610.

The electronic device 101 may determine whether to change a display order of the notification object related to the specific person to a top priority order in operation 640, and when the display order of the notification object related to the specific person needs to be changed to the top priority order, the electronic device 101 may change the display order of the notification object related to the specific person needs to the top priority order in operation 660. In the meantime, when the display order of the notification object related to the specific person does not need to be changed to the top priority order, operation 660 is omitted, and the electronic device 101 proceeds to operation 670.

In operation 670, the electronic device 101 may control the notification object related to the specific person to be displayed on at least one of the electronic device and the accessory device. To this end, the electronic device 101 may provide display order change information about the notification object related to the specific person or information about an execution start of a function related to the specific person to the accessory device 108, or display the notification object, of which the display order is changed to the top priority order, on a display functionally connected with the electronic device 101.

The electronic device 101 may determine whether the specific person related function execution is terminated in operation 680, and when the specific person related function execution is terminated, the electronic device 101 may return the display order, which is changed to the top priority order, of the notification object to a previous order according to a notification log in operation 690. In the meantime, when specific person related function execution is not terminated, the electronic device 101 may return to operation 670 and display the notification object related to the specific person on at least one of the electronic device and the accessory device.

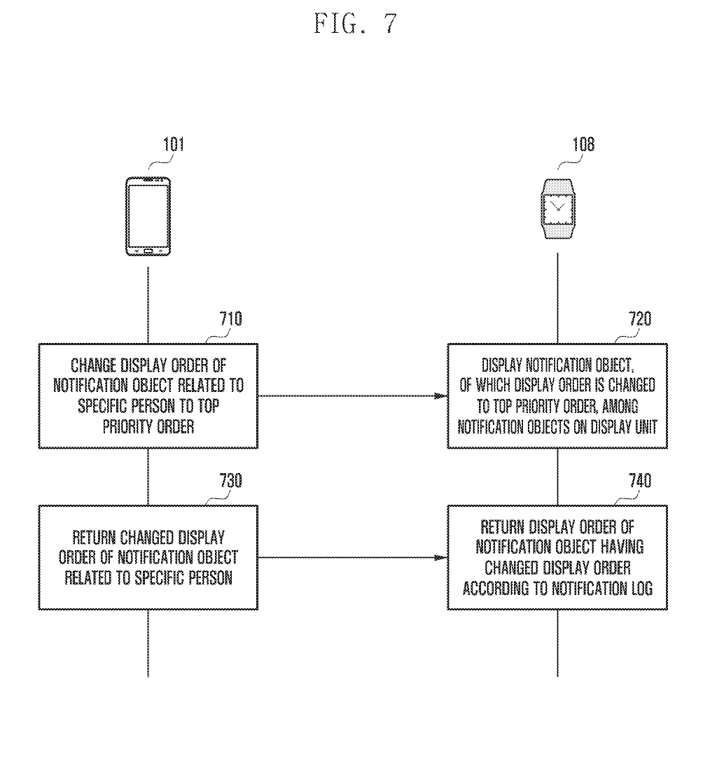

FIG. 7 is a conceptual diagram for describing an operation of a peripheral device interconnected with an electronic device according to various embodiments of the present disclosure.

Referring to FIG. 7, the electronic device 101 may share a notification object with the accessory device 108 through a notification application. In operation 710, when a display order of a notification object related to a specific person is changed to a top priority order, the electronic device 101 may transmit ID information about the notification object, of which the display order is changed to the top priority order, and change information about the display order to the accessory device 108. In this case, the electronic device 101 and the accessory device 108 may be connected through short-range communication, for example, Wi-Fi and BT communication.

In operation 720, the accessory device 108 may confirm a notification object which is interconnected with an ID of the notification object, of which the display order is changed to the top priority order, and stored in the accessory device, re-align the notification object according to the changed display order, and display the notification object having the top priority order on a display functionally connected with the accessory device 108.

In operation 730, when the display order of the notification object related to the specific person is returned, the electronic device 101 may transmit return information to the accessory device 108. In operation 740, the accessory device 108 may confirm the return information about the notification object, and re-align the display order of the notification object related to the specific person to return to a previous order according to a notification log.

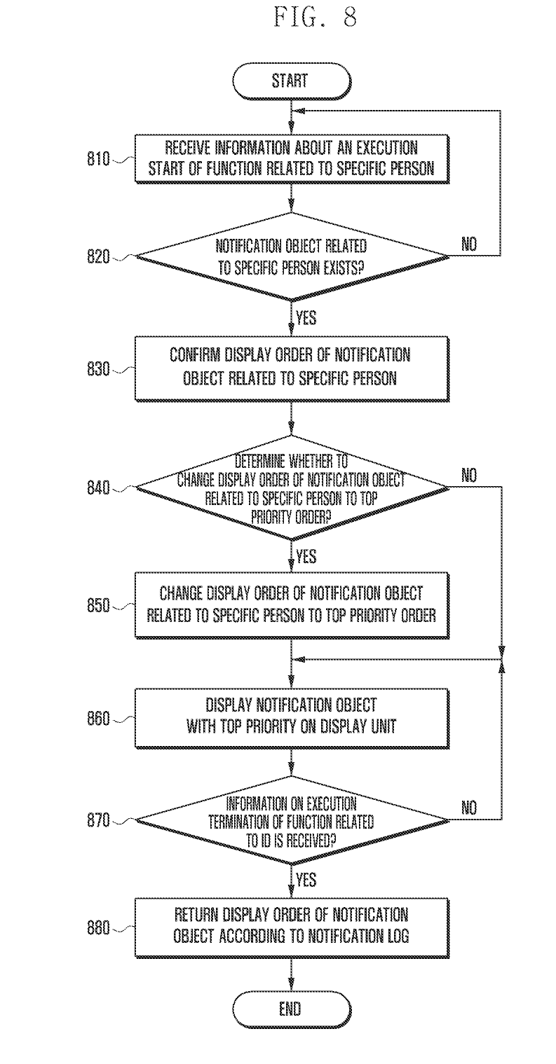

FIG. 8 is a flowchart for describing a notification function operating method of a peripheral device connected with an electronic device according to various embodiments of the present disclosure.

Referring to FIG. 8, according to an embodiment of the present disclosure, the accessory device 108 may receive information about an execution start of a function related to a specific person from 101 in operation 810. In this case, the electronic device 101 may transmit ID information about the specific person together with the information on the execution start of the function to the accessory device 108.

The accessory device 108 may determine whether a notification object including an ID of the specific person exists in operation 820, and when the notification object including an ID of the specific person exists, the accessory device 108 may confirm a display order of a notification object related to the specific person in operation 830. However, when a notification object related to the specific person does not exist, the accessory device 108 returns to operation 810.

The accessory device 108 may determine whether to change the display order of the notification object related to the specific person in operation 840, and when the display order of the notification object related to the specific person needs to be changed to the top priority order, the accessory device 108 may change the display order of the notification object related to the specific person needs to the top priority order in operation 850. In operation 860, the accessory device 108 may display the notification object, of which the display order is changed to the top priority order, on a display functionally connected with the accessory device.

When the display order of the notification object related to the specific person does not need to be changed, operation 850 is omitted, and the accessory device 108 may display the notification object having the top priority order on a display functionally connected with the accessory device in operation 860.

The accessory device 108 may determine whether information on execution termination of the function is received from the electronic device 101 in operation 870, and when the information on the execution termination of the function is received from the electronic device 101, the accessory device 108 may re-align a display order of an unconfirmed notification object related to the specific person to a previous order according to a notification log in operation 880.

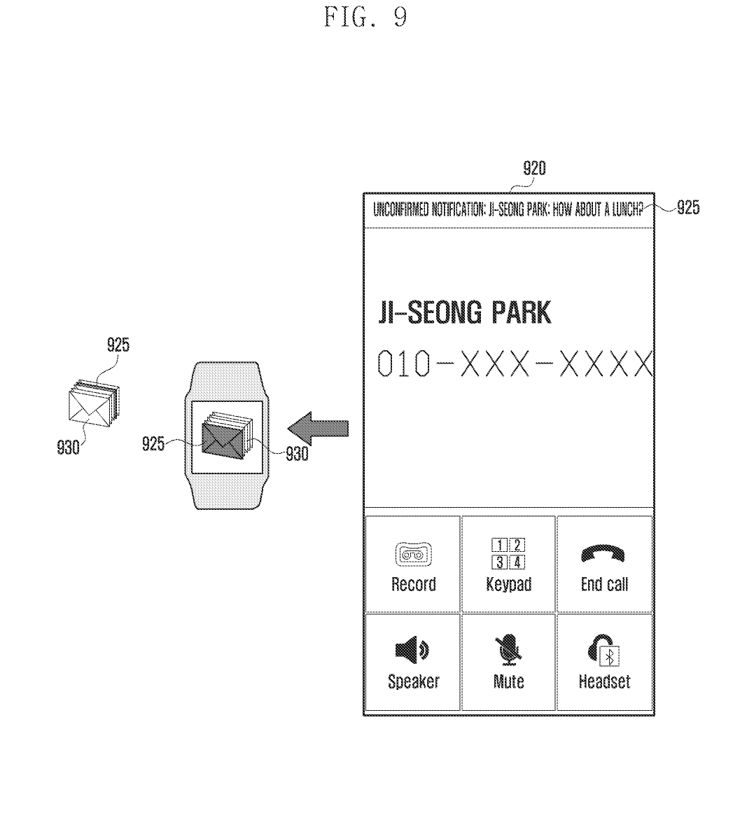

FIG. 9 is a diagram illustrating an example of a screen image of a notification service operating method according to various embodiments of the present disclosure.

Referring to FIG. 9, the electronic device may display a function execution screen image according to a request for execution of a function related to a specific person.

For example, a call reception event is detected as “Ji-Seong PARK”, the electronic device executes a call application in response to the detected call reception event, and display a call reception screen image 920 related to “Ji-Seong PARK” on the display thereof. In the meantime, the electronic device may include a plurality of notification objects 925 and 930, and the plurality of notification objects 925 and 930 may be aligned according to a predefined order or a generation order, and a display order may be applied to the plurality of notification objects 925 and 930 according to an alignment order.

The electronic device may determine whether the notification object 925 related to “Ji-Seong PARK” exists, and change a display order of the notification object 925 related to “Ji-Seong PARK” to a top priority order. For example, the notification object 925 corresponding to a message sent by “Ji-Seong PARK” exists, but the display order of the message notification object 925 related to “Ji-Seong PARK” may be aligned to the fourth order. When a call connection is requested from “Ji-Seong PARK”, the electronic device changes a priority order of the message notification object 925 related to “Ji-Seong PARK” to a top priority order. Accordingly, the notification object 925 related to “Ji-Seong PARK” may be aligned to have the first order, and the notification object 930 having the top priority order may be aligned to have the second order. The electronic device may display the notification object, of which the display order is changed to the top priority order, that is, the notification object 925 related to “Ji-Seong PARK”, on the display of the electronic device. For example, a call connection reception may be generated in a state where a user of the electronic device fails to confirm a message sent by “Ji-Seong PARK”. The electronic device may change a display order of the notification object corresponding to the message sent by “Ji-Seong PARK” to the top priority order, and display the notification object 925 corresponding to the message sent by “Ji-Seong PARK” on a notification status bar. The user may confirm the message sent by “Ji-Seong PARK” while talking with “Ji-Seong PARK” on the phone. The notification object 925 may be displayed on an uppermost end region of the call reception screen image 920, or a display region may be divided so that the notification object 925 is displayed, or the notification object 925 may overlap the call reception screen image 920 to be displayed.

Then, when a call event with “Ji-Seong PARK” is terminated, the top priority order assigned to the notification object 925 related to “Ji-Seong PARK” may return to a previous order according to a notification log. For example, when a previous display order of the notification object related to “Ji-Seong PARK” is the fourth order, the top priority order assigned to the notification object 925 related to “Ji-Seong PARK” returns to the fourth display order, and the notification object, which has been re-aligned to the second order, may be re-aligned to the top priority order (e.g., the first order).

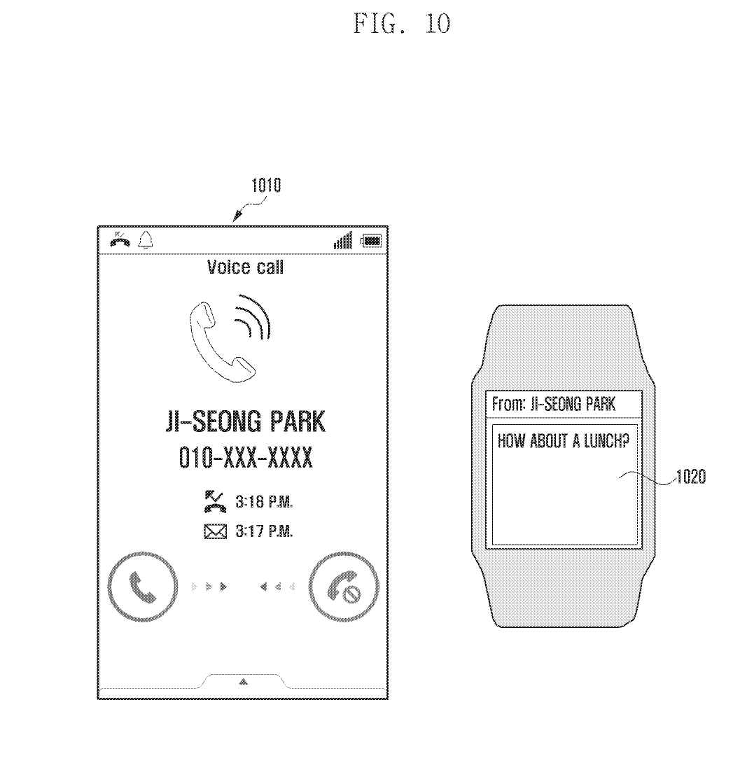

FIG. 10 is a diagram illustrating an example of a screen image of a notification service operating method according to various embodiments of the present disclosure.

Referring to FIG. 10, the electronic device may display a function execution screen image according to a request for execution of a function related to a specific person on the display, and when a notification object related to the specific person exists, the accessory device may display the notification object related to the specific person on the display of the accessory device.

When a call reception event from “Ji-Seong PARK” is detected, the electronic device displays a call reception screen image 1010 related to “Ji-Seong PARK” on the display in response to the detected call reception event, and change a display order of a notification object 1020 related to “Ji-Seong PARK” to a top priority order, and transmit information on the change of the display order to the accessory device or transmit information about an execution start of a call reception function to the accessory device. The accessory device may display the notification object 1020 related to “Ji-Seong PARK” on the display of the accessory device based on the information on the change of the display order or the information on the execution start of the call reception function received from the electronic device.

An example of an additional operation for changing a display order of an unconfirmed notification object related to a specific person when the electronic device of the present disclosure executes a function related to the specific person will be described.

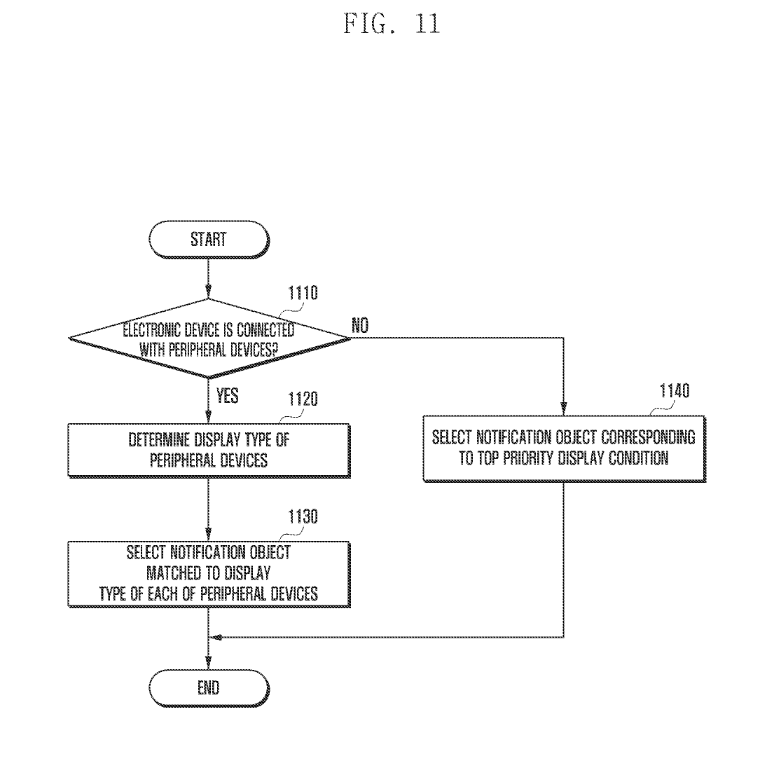

FIG. 11 is a flowchart for describing a notification function operating method of an electronic device according to various embodiments of the present disclosure.

Referring to FIG. 11, in various embodiments of the present disclosure, the electronic device may be simultaneously connected with a plurality of peripheral devices (e.g., a smart watch, smart glasses, and a peripheral electronic device). The electronic device may select a notification object to be transmitted to a peripheral device from unconfirmed notification objects related to a specific person according to the display type of connected peripheral devices.

When a display order of the notification object related to the specific person needs to be changed, the electronic device may determine whether the electronic device is connected with the plurality of peripheral devices in operation 1110. When the electronic device is connected with the plurality of peripheral devices, the electronic device may determine the display type of connected peripheral devices in operation 1120.

In various embodiments of the present disclosure, the electronic devices may be set to have intrinsic identification information classified according to the type of electronic device. The electronic device may obtain intrinsic identification information about the device when being connected with the peripheral devices. The electronic device may confirm the type of device based on the identification information, and classify the type of display of the devices according to the type. For example, the device, such as a smart watch, has a limitation in the size of a display unit, so that the device, such as a smart watch, may be appropriate to display notification information having relatively small display data, such as a message and a schedule. The device, such as smart glasses, does not have a large limitation in the size of display information, so that the device, such as smart glasses, may be appropriate to display notification information having relatively large display data, such as an email, a memo, and an image.

In various embodiments of the present disclosure, the electronic device may set a display type to be determined based on the type of connected peripheral device, and set the type of notification object matched to the corresponding display type to be classified. For example, the electronic device having the display type of the smart glasses may be set so that an object, such as email notification, memo notification, and image notification, is selected, and the electronic device having the display type of the smart watch may be set so that an object, such as message notification and schedule notification, is selected. The electronic device having the display type of the smart TV may be set so that an object, such as video reception notification, is selected, and the electronic device may be variously set according to the type of all of the electronic devices connectable with the electronic device.

In operation 1130, the electronic device may select each unconfirmed notification objects matched to the display type of peripheral devices. For example, the electronic device may be simultaneously connected with a smart watch, smart glasses, and a smart TV. In this case, the electronic device may include an email notification object, a video reception notification object, and a message notification object among unconfirmed notification objects related to a specific person. The electronic device may select the email notification object as an object to be transmitted to the smart glasses, and select the video reception notification object to an object to be transmitted to the smart TV. The electronic device may select the message notification object as an object to be transmitted to the smart watch.

The electronic device may transmit information on a change of display orders of the selected notification objects or notification object information to each of the devices. Then, the electronic device may confirm the notification object information related to the specific person through the plurality of connected devices through the peripheral device connected with the electronic device when a function related to the specific person is performed.

In operation 1140, when the electronic device is not connected with a plurality of devices, but is connected with one peripheral device, the electronic device may select a notification object corresponding to a top priority display condition from the unconfirmed notification objects. For example, when the notification objects related to the specific person are aligned in a time series order, the electronic device may set a last generated notification object under the top priority display condition.

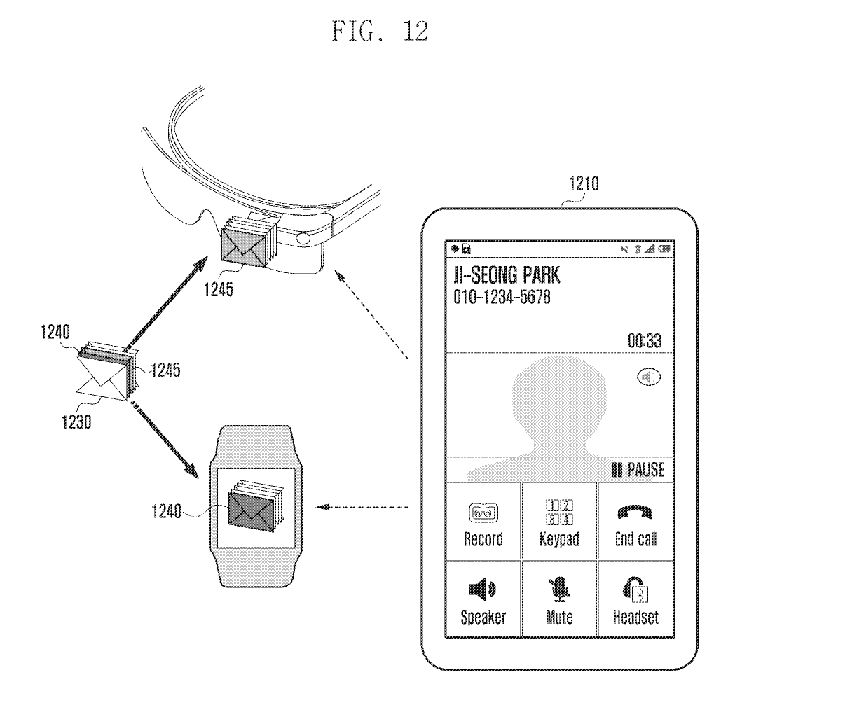

FIG. 12 is a diagram illustrating an example of a screen image of a notification service operating method according to various embodiments of the present disclosure.

Referring to FIG. 12, the electronic device may be connected with a plurality of peripheral devices. The electronic device may display an execution screen image of a function related to a specific person on the display, and control notification objects related to the specific person to be displayed on a display of each accessory device according to the display type of connected peripheral devices. The electronic device may confirm the notification objects related to the specific person among the plurality of notification objects, and select each of the unconfirmed notification objects related to the specific person according to the display type of peripheral devices.

When a call reception event from “Ji-Seong PARK” is detected, the electronic device may display a call reception screen image 1210 related to “Ji-Seong PARK” on the display in response to the detected call reception event. In this case, there may exist a message notification object 1240 and an email notification object 1245 related to “Ji-Seong PARK” in unconfirmed notification objects 1230, 1240, and 1245. The electronic device may select the message notification object 1240 as an object to be transmitted to a smart watch, and select the email notification object 1245 as an object to be transmitted to smart glasses.

The electronic device may transmit information on a change of display orders of the notification objects 1240 and 1245 related to “Ji-Seong PARK” or information about an execution start of a call reception function to the smart glasses and the smart watch. Then, the smart watch may display the message notification object 1240 on a display thereof, and the smart glasses may display the email notification object 1245.

In various embodiments of the present disclosure, the electronic device may also determine whether to transmit a notification object related to a specific person according to the display type of peripheral devices, or transmit contents connected with a notification object related to a specific person. When a peripheral device connected with the electronic device has the display type (e.g., a smart watch and a smart TV) having no limitation in displaying information, the electronic device may control contents corresponding to a notification object to be displayed on a display of the peripheral device. For example, when the electronic device is connected with a smart TV, the electronic device may display email contents received from a specific person through the smart TV, or video contents received from the specific person through the smart TV.

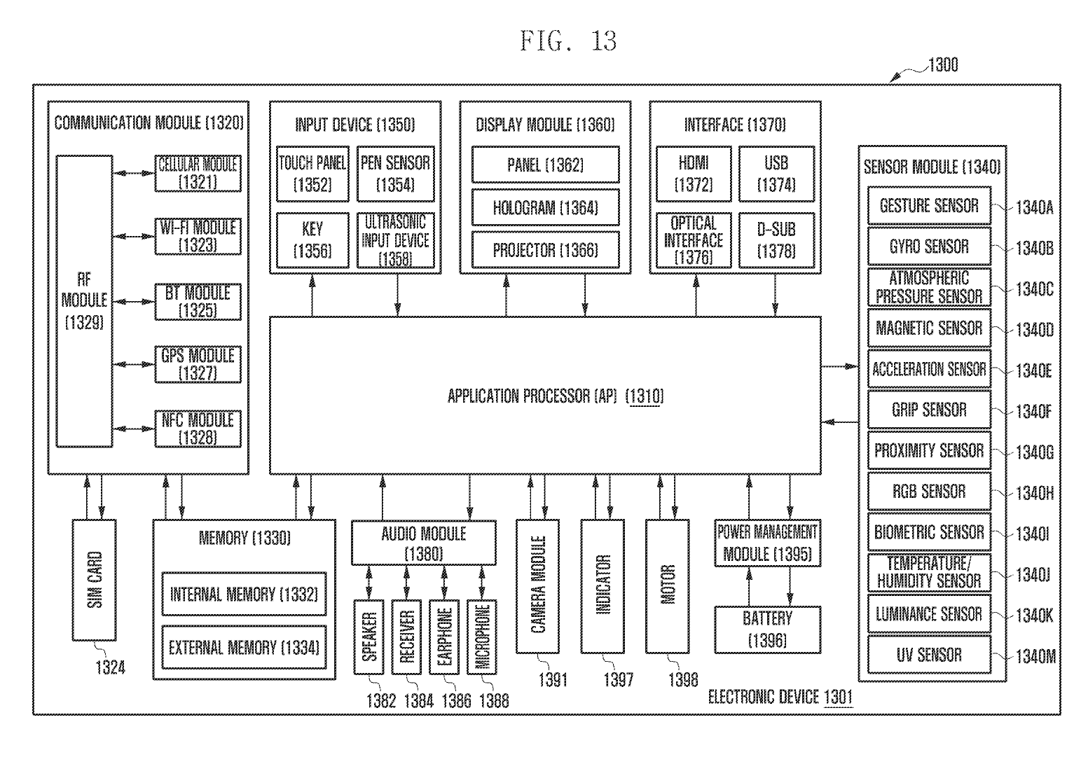

FIG. 13 is a block diagram illustrating a configuration of an electronic device according to an embodiment of the present disclosure.

Referring to FIG. 13, an electronic device 1301 may include an processor 1310, a communication module 1320, a Subscriber Identity Module (SIM) card 1324, a memory 1330, a sensor module 1340, an input device 1350, a display 1360, an interface 1370, an audio module 1380, a camera module 1391, a power management module 1395, a battery 1396, an indicator 1397, and a motor 1398.

The processor 1310 may include an Application Processor (AP) 1311 and a Communication Processor (CP) 1313, and may operate an Operating System (OS) and/or application programs to control a plurality of hardware and/or software components connected to the AP 1310 and perform data-processing and operations on multimedia data. For example, the AP 1310 may be implemented in the form of System on Chip (SoC). According to an embodiment of the present disclosure, the AP 1310 may include a Graphic Processing Unit (GPU) (not shown).

The communication module 1320 (e.g. communication interface 160) may perform data communication with other electronic devices (e.g. electronic device 104 and server 106) through a network. According to an embodiment of the present disclosure, the communication module 1320 may include a cellular module 1321, a Wi-Fi module 1323, a BT module 1325, a GPS module 1327, an NFC module 1328, and a Radio Frequency (RF) module 1329.

The cellular module 1321 is responsible for voice and video communication, text messaging, and Internet access services through a communication network (e.g. LTE, LTE-A, CDMA, WCDMA, UMTS, WiBro, and GSM networks). The cellular module 1321 may perform identification and authentication of electronic devices in the communication network using the SIM card 1324. The cellular module 1321 may perform at least one of the functions of the AP 1310. For example, the cellular module 1321 may perform at least a part of the multimedia control function.

The cellular module 1321 may be implemented in the form of SoC. Although the cellular module 1321, the memory 1330, and the power management module 1395 are depicted as independent components separated from the AP 1310, the present disclosure is not limited thereto but may be embodied in a way that the AP includes at least one of the components (e.g. cellular module 1321).

Each of the AP 1310 and the cellular module 1321 may load a command or data received from at least one of the components on a non-volatile or volatile memory and process the command or data. The AP 1310 or the cellular module 1321 may store the data received from other components or generated by at least one of other components in the non-volatile memory.

Each of the Wi-Fi module 1323, the BT module 1325, the GPS module 1327, and the NFC module 1328 may include a processor for processing the data it transmits/receives. Although the cellular module 1321, the Wi-Fi module 1323, the BT module 1325, the GPS module 1327, and the NFC module 1328 are depicted as independent blocks, at least two of them (e.g. communication processor corresponding to the cellular module 1321 and Wi-Fi processor corresponding to the Wi-Fi module 1323) may be integrated in the form of SoC.

The RF module 1329 is responsible for data communication (e.g. transmitting/receiving RF signals). Although not depicted, the RF module 1329 may include a transceiver, a Power Amp Module (PAM), a frequency filter, and a Low Noise Amplifier (LNA). The RF module 1329 also may include the elements for transmitting/receiving electric wave in free space, e.g. conductor or conductive wire. Although FIG. 13 is directed to the case where the Wi-Fi module 1323, the BT module 1325, the GPS module 1327, and the NFC module 1328 are sharing the RF module 1329, the present disclosure is not limited thereto but may be embodied in a way that at least one of the Wi-Fi module 1323, the BT module 1325, the GPS module 1327, and the NFC module 1328 transmits/receives RF signals an independent RF module.

The SIM card 1324 may be designed so as to be inserted into a slot formed at a predetermined position of the electronic device. The SIM card 1324 may store unique identity information (e.g., Integrated Circuit Card Identifier (ICCID)) or subscriber information (e.g., International Mobile Subscriber Identity (IMSI)).

The memory 1330 (e.g. memory 130) may include at least one of the internal memory 1332 and an external memory 1334. The internal memory 1332 may include at least one of a volatile memory (e.g. Dynamic Random Access Memory (DRAM), Static RAM (SRAM), Synchronous DRAM (SDRAM) or a non-volatile memory (e.g. One Time Programmable Read Only Memory (OTPROM), PROM, Erasable and Programmable ROM (EPROM), Electrically Erasable and Programmable ROM (EEPROM), mask ROM, flash ROM, NAND flash memory, and NOR flash memory).

The internal memory 1332 may be a Solid State Drive (SSD). The external memory 1334 may be a flash drive such as Compact Flash (CF), Secure Digital (SD), micro-SD, Mini-SD, extreme Digital (xD), and Memory Stick. The external memory 1334 may be functionally connected to the electronic device 1301 through various interfaces. The electronic device 1300 may include a storage device (or storage medium) such as hard drive.

The sensor module 1340 may measure physical quantity or check the operation status of the electronic device 1300 and convert the measured or checked information to an electric signal. The sensor module 1340 may include at least one of gesture sensor 1340A, gyro sensor 1340B, atmospheric pressure sensor 1340C, magnetic sensor 1340D, acceleration sensor 1340E, grip sensor 1340F, proximity sensor 1340G, color sensor 1340H (e.g. Red, Green, Blue (RGB) sensor), bio sensor 1340I, temperature/humidity sensor 1340J, illuminance sensor 1340K, and Ultra Violet (UV) sensor 1340M. Additionally or alternatively, the sensor module 1340 may include E-nose sensor (not shown), Electromyography (EMG) sensor (not shown), Electroencephalogram (EEG) sensor (not shown), Electrocardiogram (ECG) sensor (not shown), Infrared (IR) sensor (not shown), iris sensor (not shown), and fingerprint sensor (not shown). The sensor module 1340 may further include a control circuit for controlling at least one of the sensors included therein.

The input device 1350 may include a touch panel 1352, a (digital) pen sensor 1354, keys 1356, and an ultrasonic input device 1358. The touch panel 1352 may be one of capacitive, resistive, infrared, microwave type touch panel. The touch panel 1352 may include a control circuit. In the case of the capacitive type touch panel, it is possible to detect physical contact or approximation. The touch panel 1352 may further include a tactile layer. In this case, the touch panel 1352 may provide the user with haptic reaction.

The (digital) pen sensor 1354 may be implemented with a sheet with the same or similar way as touch input of the user or a separate recognition sheet. The keys 1356 may include physical buttons, optical key, and keypad. The ultrasonic input device 1358 is a device capable of checking data by detecting sound wave through a microphone 1388 and may be implemented for wireless recognition. According to an embodiment of the present disclosure, the electronic device 1301 may receive the user input made by means of an external device (e.g. computer or server) connected through the communication module 1320.

The display 1360 (e.g. display module 150) may include a panel 1362, a hologram device 1364, and a projector 1366. The panel 1362 may be a Liquid Crystal Display (LCD) panel or an Active Matrix Organic Light Emitting Diodes (AMOLED) panel. The panel 1362 may be implemented so as to be flexible, transparent, and/or wearable. The panel 1362 may be implemented as a module integrated with the touch panel 1352. The hologram device 1364 may present 3-dimensional image in the air using interference of light. The projector 1366 may project an image to a screen. The screen may be placed inside or outside the electronic device. According to an embodiment of the present disclosure, the display 1360 may include a control circuit for controlling the panel 1362, the hologram device 1364, and the projector.

The interface 1370 may include an HDMI 1372, a USB 1374, an optical interface 1376, and a D-subminiature (D-sub) 1378. The interface 1370 may include the communication interface 160 as shown in FIG. 1. Additionally or alternatively, the interface 1370 may include a Mobile High-definition Link (MHL) interface, an SD/Multimedia Card (MMC) card interface, and infrared Data Association (irDA) standard interface.

The audio module 1380 may convert sound to electric signal and vice versa. At least a part of the audio module 1380 may be included in the input/output interface 140 as shown in FIG. 1. The audio module 1380 may process the audio information input or output through the speaker 1382, the receiver 1384, the earphone 1386, and the microphone 1388.

The camera module 1391 is a device capable of taking still and motion pictures and, may include at least one image sensor (e.g. front and rear sensors), a lens (not shown), and Image Signal Processor (ISP) (not shown), and a flash (e.g. LED or xenon lamp) (not shown).

The power management module 1395 may manage the power of the electronic device 1301. Although not shown, the power management module 1395 may include a Power Management Integrated Circuit (PMIC), a charger IC, a battery, and a battery or fuel gauge.

The PMIC may be integrated into an integrated circuit or SoC semiconductor. The charging may be classified into wireless charging and wired charge. The charger IC may charge the battery and protect the charger against overvoltage or overcurrent. According to an embodiment of the present disclosure, the charger IC may include at least one of wired charger and wireless charger ICs. Examples of the wireless charging technology includes resonance wireless charging and electromagnetic wave wireless charging, and there is a need of extra circuit for wireless charging such as coil loop, resonance circuit, and diode.

The battery gauge may measure the residual power of the battery 1396, charging voltage, current, and temperature. The battery 1396 may store or generate power and supply the stored or generated power to the electronic device 1300. The battery 1396 may include a rechargeable battery or a solar battery.

The indicator 1397 may display operation status of the electronic device 1301 or a part of the electronic device, booting status, messaging status, and charging status. The motor 1398 may convert the electronic signal to mechanical vibration. Although not shown, the electronic device 1300 may include a processing unit (e.g. GPU) for supporting mobile TV. The processing unit for supporting the mobile TV may be able to processing the media data abiding by the broadcast standards such Digital Multimedia Broadcasting (DMB), Digital Video Broadcasting (DVB), and media flow.

As described above, the text display method and apparatus of an electronic device of the present disclosure is advantageous in terms of reducing a number of page scrolls by discerning the paragraphs included in a text document and folding the paragraphs to present parts of the respective paragraphs.

Also, the text display method and apparatus of an electronic device of the present disclosure is advantageous in terms of improving the legibility of the text in such a way of enlarging, when a folded paragraph is stretched, the font size of the paragraph or highlighting the paragraph.

The above enumerated components of the electronic device of the present disclosure may be implemented into one or more parts, and the names of the corresponding components may be changed depending on the kind of the electronic device. The electronic device of the present disclosure may include at least one of the aforementioned components with omission or addition of some components. The components of the electronic device of the present disclosure may be combined selectively into an entity to perform the functions of the components equally as before the combination.

The term “module” according to various embodiments of the present disclosure, means, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be the smallest unit of performing at least one function or a part thereof. A module may be implemented mechanically or electronically. For example, a module may include at least one of Application-Specific IC (ASIC) chip, Field-Programmable Gate Arrays (FPGAs), and Programmable-Logic Device known or to be developed for certain operations.

According to various embodiments of the present disclosure, the devices (e.g. modules or their functions) or methods may be implemented by computer program instructions stored in a computer-readable storage medium. In the case that the instructions are executed by at least one processor (e.g. processor 120), the at least one processor may execute the functions corresponding to the instructions. The computer-readable storage medium may be the memory 130. At least a part of the programing module may be implemented (e.g. executed) by the processor 120. At least part of the programing module may include modules, programs, routines, sets of instructions, and processes for executing the at least one function.

The computer-readable storage medium includes magnetic media such as a floppy disk and a magnetic tape, optical media including a Compact Disc (CD) ROM and a DVD ROM, a magneto-optical media such as a floptical disk, and the hardware device designed for storing and executing program commands such as ROM, RAM, and flash memory. The programs command include the language code executable by computers using the interpreter as well as the machine language codes created by a compiler. The aforementioned hardware device can be implemented with one or more software modules for executing the operations of the various embodiments of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing information by an electronic device, the method comprising:
executing a function related to a specific person while executing a function of a first electronic device;
changing a display order of information related to the specific person when the information related to the specific person exists; and
transmitting a changed matter of the changed information to a second electronic device.

2. The method of claim 1,
wherein the information related to the specific person is a notification object, and
wherein the changing of the display order includes changing a display order of the notification object to a top priority order.

3. The method of claim 2, wherein the information related to the specific person is an unconfirmed notification object.

4. The method of claim 1, further comprising:
displaying the changed matter of the changed information on a display of the first electronic device after the changing of the information related to the specific person.

5. The method of claim 1, wherein the displaying of the information on the changed matter on the display of the first electronic device comprises displaying a function execution screen image in response to execution of the function related to the specific person, and displaying the changed information on a function execution screen image.

6. The method of claim 5, wherein the displaying of the changed information comprises displaying the information on the changed matter while overlapping the information on the changed matter and a specific region of the function execution screen image, or dividing a screen and displaying the information on the changed matter.

7. The method of claim 1, wherein the executing of the function related to the specific person is an execution event of at least one of a call connection function with the specific person, a message sending/receiving function, an email sending/receiving function, a social networking site (SNS) function such as talk message execution and SNS content execution) associated to the specific person, a schedule associated with the specific person, and a memo function related to the specific person.

8. The method of claim 1, wherein the changing of the display order further comprises:
comparing identification information about the specific person with generation information about information related to the specific person; and
determining whether information containing the identification information about the specific person exists.

9. The method of claim 1, wherein the information about the specific person includes at least one of absence call notification, message notification, messenger notification, email notification, event notification, and schedule notification.

10. The method of claim 3, further comprising:
returning, when the execution of the function related to the specific person is terminated or the unconfirmed notification object is read, order information about the notification object, of which the display order is changed to the top priority order, to a previous order after the changing of the display order of the notification object to the top priority order.

11. The method of claim 1, wherein the transmitting of the information on the changed matter to the second electronic device comprises:
selecting, when a plurality of second electronic devices is connected with the first electronic device, an unconfirmed notification object matched with each of the second electronic devices based on a display type of the second electronic device; and
transmitting change information about the selected notification object.

12. A method of providing a notification object by an electronic device connected with a peripheral device, the method comprising:
receiving information about an execution start of a function related to a specific person or information on a changed order of a specific notification object from a peripheral device;
changing a display order of a notification object related to the specific person in response to the information about an execution start of the function or the order information; and
displaying the notification object, of which the display order is changed, on a display functionally connected with the electronic device.

13. An electronic device comprising:
a communication module configured to wirelessly communicate with other electronic devices;
a processor configured:
to execute a function related to a specific person,
to change a display order of information related to the specific person when the information related to the specific person exists, and
to provide at least one of the changed information or a change matter of the changed information to one or more accessory devices; and
a display configured to display at least one of the function related to the specific person and the information related to the specific person.

14. The electronic device of claim 13, wherein the processor is further configured:
to obtain notification object generation information based on the information related to the specific person from an application corresponding to a notification event when the notification event is detected,
to generate a notification object based on the notification object generation information, and
to assign a display order to the notification object in a predetermined order or a time series order.

15. The electronic device of claim 13, wherein, when the information related to the specific person is an unconfirmed notification object, the processor is further configured to change a display order of the unconfirmed object related to the specific person to a top priority order.

16. The electronic device of claim 14, wherein the processor is further configured:
to allocate an Identification (ID) of the notification object, and
to provide the notification object an accessory device in connection with the ID of the notification object.

17. The electronic device of claim 13, wherein the processor is further configured to control the information related to the specific person to be displayed on a part of a screen image of execution of a function related to the specific person.

18. The electronic device of claim 13, wherein, when execution of a function related to the specific person is terminated, the processor is further configured to re-align the display order of the changed information to a previous order.

19. The electronic device of claim 13, wherein, when a plurality of other electronic devices is connected with the electronic device, the processor is further configured:
to select an unconfirmed notification object matched to each of the other electronic devices based on display types of the other electronic devices, and
to transmit changed information about the selected notification object to other electronic devices.

20. An electronic device comprising:
a communication module configured to wirelessly communicate with other electronic devices;
a processor configured:
to receive a notification object from the electronic device, and
to align a display order of the notification object related to a specific person to a top priority order when at least one of display order information about the notification object and execution information about a function related to a specific person is received, and the notification object related to the specific person exists; and
a display configured to display the notification object related to the specific person.

21. The electronic device of claim 20, wherein the displaying of the notification object is changed in form based on a type of the electronic device displaying the notification object.
